(19) United States
(12) Patent Application Publication
(10) Pub. No.: US 2007/0166193 A1
(43) Pub. Date: Jul. 19, 2007

(54) Reagent kit and analytical apparatus

(75) Inventors: Gerhard Veen, Rotkreuz (CH); Peter Fanger, Rotkreuz (CH)

Correspondence Address: DINSMORE & SHOHL, LLP;ONE DAYTON CENTRE, ONE SOUTH MAIN STREET, SUITE 1300, DAYTON, OH, 45402, US

(73) Assignee: Roche Diagnostics Operations, Inc., Indianapolis, IN (US)

(21) Appl. No.: 11/652,293

(22) Filed: Jan. 11, 2007

(30) Foreign Application Priority Data
Jan. 13, 2006 (EP) EP06075094.0

(51) Int. Cl. B01L 3/00

(52) U.S. Cl. 422/61

(57) ABSTRACT

A reagent kit adapted for being used in an automatic analytical apparatus. The reagent kit comprises at least a first reagent container and a second reagent container which have the same height, a kit cover for covering and for holding the upper parts of said at least two reagent containers together, a first tray for holding the bottom part of the first reagent container, and a second tray for holding the bottom part of the second reagent container. Reagent containers are so configured and dimensioned that when they are assembled together they fill the entire space comprised between kit cover and the trays with exception of a tubular volume which allows air circulation through said reagent kit. The sum of the height of the side walls of the kit cover and the height of the side walls of the trays is smaller than the height of the reagent containers.

### FIELD OF THE INVENTION

The present invention relates generally to chemistry analyzers, and in particular to a reagent kit for use in an automatic analytical apparatus.

### BACKGROUND OF THE INVENTION

In automatic clinical chemistry analyzers, it is desirable to process reagent kits which hold reagent containers completely automatically. Before being first used in the analyzer and between pipetting operations, the reagent containers also should be kept closed by a closure to avoid loss of reagent or shortening the useful life of the reagents.

U.S. Pat. No. 5,578,272 describes a prior art reagent kit of the above-described kind. As shown by FIG. 1 this known reagent kit 10 has a cuboid casing 81 having a bottom 82, side walls 83, 84, a removable lid 85, and reagent containers 106, 107, 108 disposed in the casing. Each of these reagent containers 106, 107, 108 has a cylindrical body and is closed by a closure 86, 87, 88 which is adapted for being perforated by a needle of a pipetting device of an analytical apparatus. Lid 85 has openings 96, 97, 98 through which the contents of the reagent containers 106, 107, 108 are accessible for automatic pipetting operations. Lid 85 and bottom 82 of casing 81 have openings which allow circulation of cooled air through the casing and around the reagent containers 106, 107, 108 in order to ensure that these containers are kept at a required temperature.

Although the above mentioned reagent kit 10 is suitable for its intended purposes, there remains a need to increase the total amount of reagents that can be stored in a reagent kit without increasing the cuboid space assigned to such a kit in an analyzer.

There is also a need to have a reagent kit with a greater variety of configurations of reagent containers of different sizes or of the same size in order to meet a wider range of different needs concerning both the amounts of reagents needed per period of use (day, week or month) and the variety of reagents needed.

There is a further need to have a reagent kit wherein one or more paths are provided for circulation of cooled air around the reagent containers in order to ensure that these are kept at the required temperature.

There is also a need to have a reagent kit which has such a structure that not only provides the above mentioned desirable features, but that also makes possible to reduce its manufacturing costs.

In order to enhance the modes of use of the reagent kit in the analyzer, there is a need to have a reagent kit structure which allows automatic removal of the caps of the reagent container with a suitable tool, and which thereby makes possible to use the reagent containers either open (after removal of their caps) or closed.

### SUMMARY OF THE INVENTION

It is against the above background that the present invention provides a reagent kit of the above mentioned kind which addresses the above mentioned needs which are not addressed by the above mentioned known reagent kit described by U.S. Pat. No. 5,578,272.

Some of the noted advantages obtained with a reagent kit according to the present invention, for example and not limited thereto, are as follows:
for a given cuboid space assigned to a reagent kit in an analytical apparatus, the amount of reagents stored in the reagent kit is maximized,
the structure of a reagent kit according to the present invention makes it possible to have several configurations of reagents of different sizes or of the same size in order to meet a wider range of different needs concerning both the amounts of reagents needed per period of use (day, week or month) and the variety of reagents needed,
one or more paths are provided for circulation of cooled air around the reagent containers in order to ensure that these are kept at the required temperature,
the structure of the reagent kit according to the present invention makes it possible to reduce its manufacturing costs, because manufacture of the reagent kit according to the present invention requires less material and because assembling the reagent kits is achieved with less work, and
the structure of the reagent kit according to the present invention makes it possible to automatically remove the screwable caps of the reagent containers with a suitable tool and to use the kit with open reagent containers, or to use the reagent containers kept closed with their respective caps, in which case the central part of the caps is piercable by a pipetting needle in order that amounts of reagent required from each reagent container can be taken with the pipetting needle.

Further it is noted, and not limited thereto, that the analytical apparatus or analyzer according to the present invention is suitable for completely automatic processing of the reagent kits according to the present invention. This reduces the need for labor in handling the analytical apparatus and also increases the reliability when performing a large number of different tests requiring a correspondingly large number of different reagents or combinations thereof.

These and other features and advantages of the present invention will be more fully understood from the following description of various embodiments of the present invention taken together with the accompanying drawings.

### BRIEF DESCRIPTION OF THE DRAWINGS

FIG. 1 shows a perspective view of a prior art reagent kit 10;

FIG. 2 shows a perspective view of an embodiment of reagent kit 11 according to the present invention;

FIG. 3 shows a side view of reagent kit 11 in FIG. 2;

FIG. 4 shows a partially exploded perspective view of the components of reagent kit 11 in FIG. 2 from a first point of view;

FIG. 5 shows a fully exploded perspective view of components of reagent kit 11 in FIG. 2 from the same point of view as the one of FIG. 4;

FIG. 6 shows a partially exploded perspective view of the components of reagent kit 11 in FIG. 2 from a second point of view opposite to the one of FIG. 5;

FIG. 7 shows a top view of cover 14 of reagent kit 11 in FIG. 2;

FIG. 8 shows a top view of containers 12 and 13 of reagent kit 11 in FIG. 2;

FIG. 9 shows a bottom view of trays 16 and 17 of reagent kit 11 in FIG. 2;

FIG. 10 shows a partially exploded perspective view of the components of another embodiment of a reagent kit 11 according to the present invention;

FIG. 11 shows a partially exploded perspective view of the components of still another embodiment of a reagent kit 11 according to the present invention;

FIG. 12 shows a perspective view of an analytical apparatus according to the present invention.

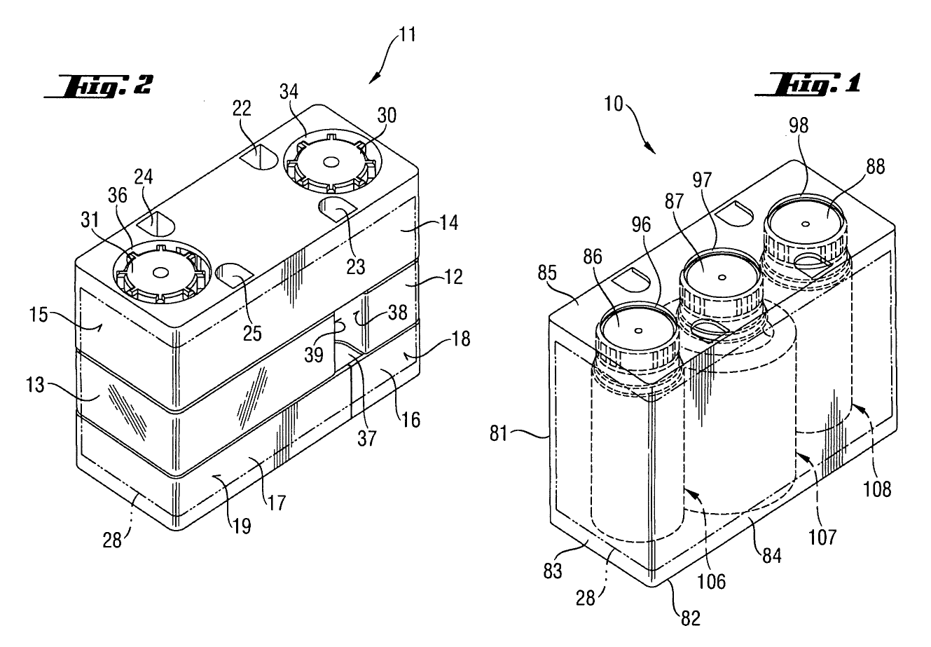

the present invention

### DETAILED DESCRIPTION OF THE INVENTION

Reference will now be made in detail to several embodiments of a reagent kit and analytical apparatus according to the invention that are illustrated in the accompanying drawinGS. These embodiments are set forth for the purpose of illustrating and aiding in the understanding of the invention, and are not to be construed as limiting. Wherever possible, same or similar reference numerals are used in the drawings and the description to refer to same or like parts. The drawings are in simplified form and may not be to precise scale. For purposes of convenience and clarity only, directional terms, such as, top, bottom, left, right, up, down, over, above, below, beneath, rear, back, front, horizontal, and vertical may be used with respect to the accompanying drawings.

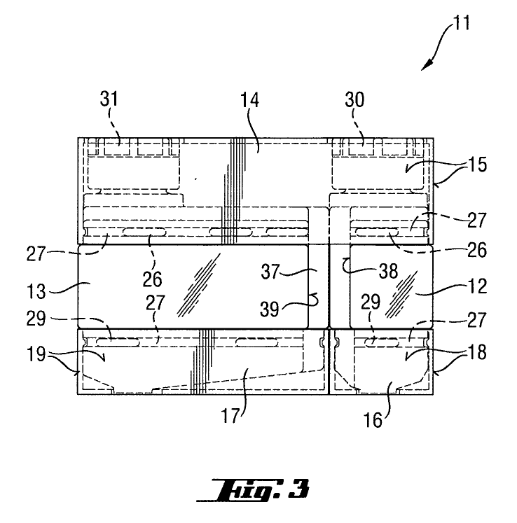

A first illustrative embodiment of a reagent kit 11 according to the present invention is described hereinafter with reference to FIGS. 2-9.

Reagent kit 11 comprises e.g. a first reagent container 12 and a second reagent container 13 which have the same height.

In one embodiment, reagent container 12 has a capacity of e.g. 20 milliliters. In one embodiment, reagent container 13 has a capacity of e.g. 60 milliliters.

Reagent kit 11 further comprises a kit cover 14 for covering and for holding the upper parts of reagent containers 12, 13 together. Kit cover 14 has openings 34 and 36 which provide access to reagents contained in reagent containers 12, 13. Kit cover 14 has side walls 15, the height of which is smaller than the height of reagent containers 12 and 13.

Reagent kit 11 further comprises a first tray 16 for holding the bottom part of reagent container 12 and a second tray 17 for holding the bottom part of reagent container 13. Trays 16 and 17 have each a side walls 18 respectively 19 the height of which is smaller than the height of reagent containers 12 and 13. Each of trays 16 and 17 serves as a standing base for the respective reagent container 12 respectively 13.

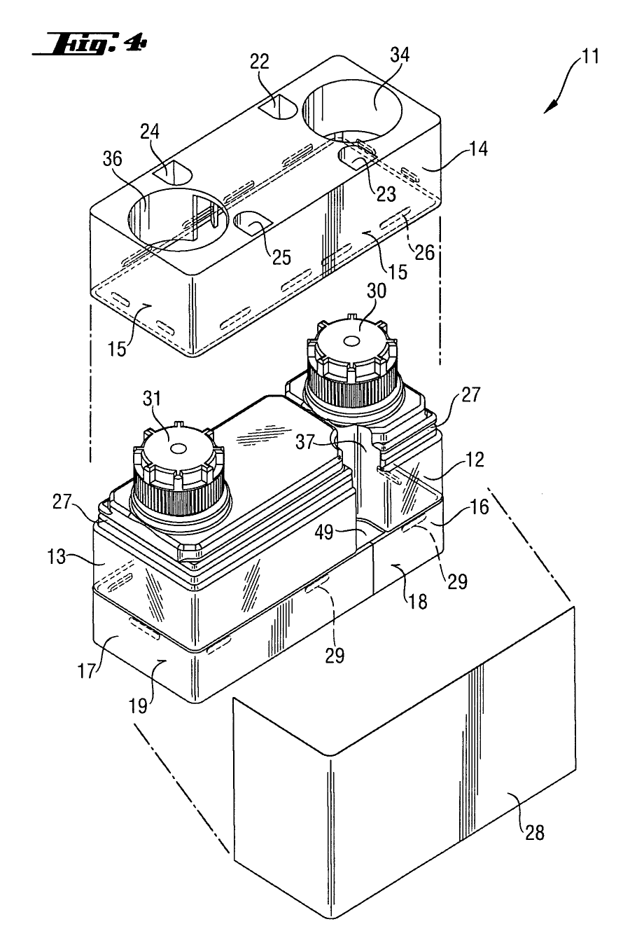

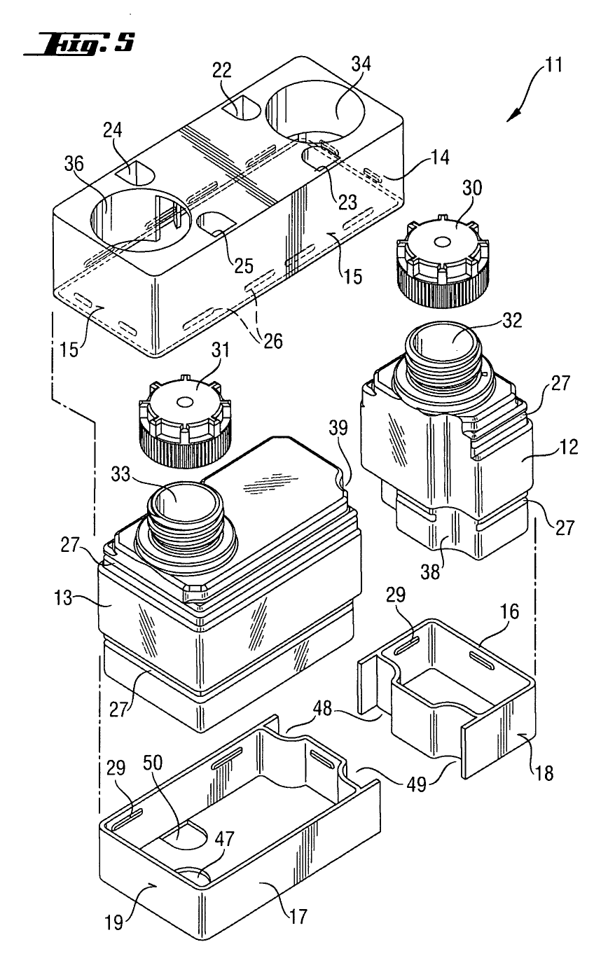

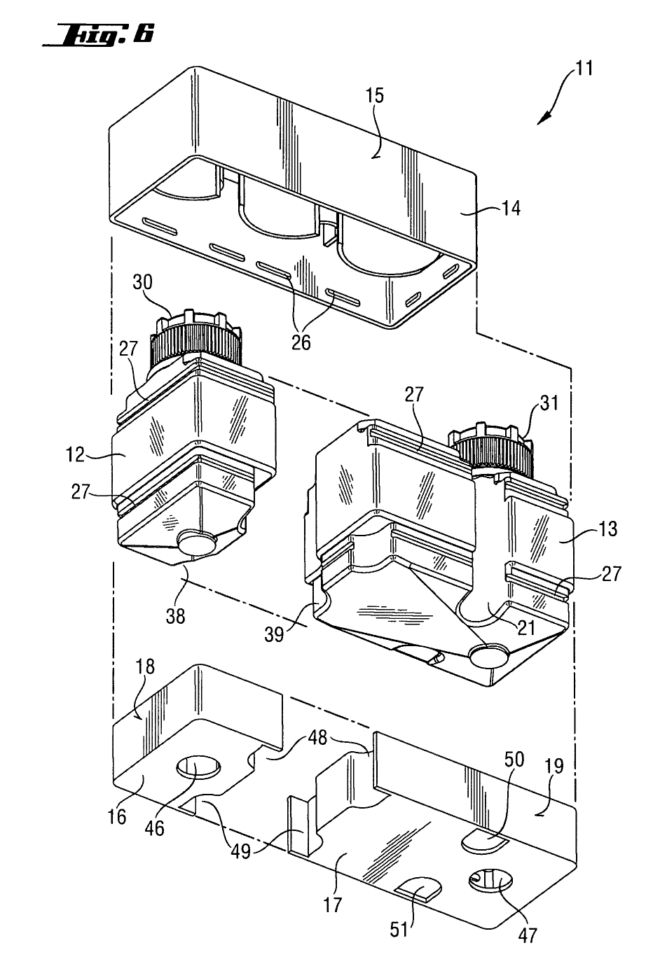

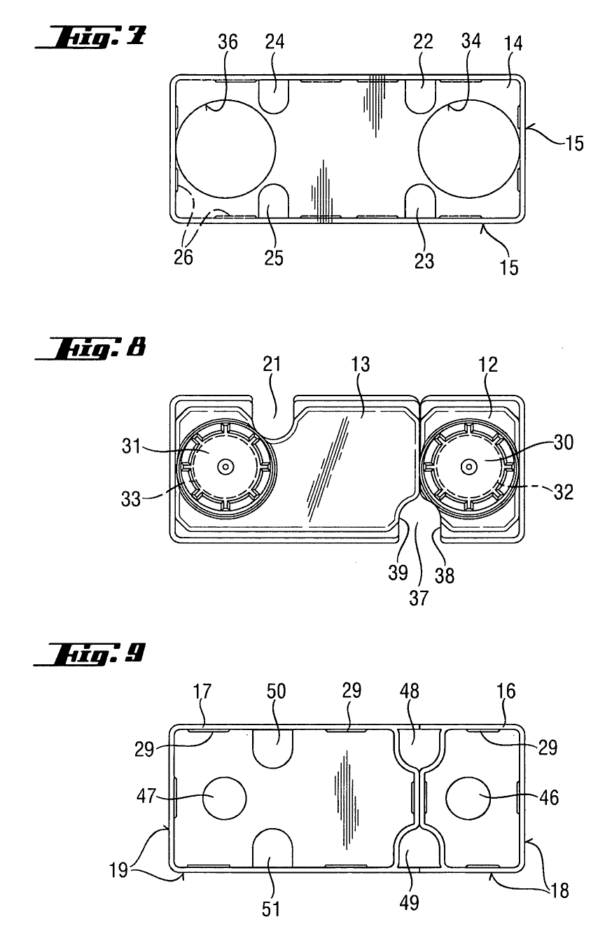

As shown by FIG. 3, in one embodiment the sum of the height of side walls 15 of kit cover 14 and the height of side walls 18, respectively 19, is smaller than the height of reagent containers 12 and 13.

Reagent containers 12 and 13 are so configured and dimensioned that when they are assembled together they fill the entire space comprised between kit cover 14 and trays 16 and 17 with exception of a tubular volume 37 best shown in FIGS. 2 to 4, and a tubular volume 21 best shown in FIG. 6, which allow circulation of cooled air through reagent kit 11. Tubular volume 37 comprises a tubular volume 38 along the side wall of reagent container 12 and a tubular volume 39 along the side wall of reagent container 13. Openings 48 and 49 in trays 16 and 17 respectively, and openings 46, 47, 50 and 51 best shown in FIG. 6, are inlets for cooled air that circulates through kit 11 in order to keep the reagents at the required temperature.

Kit cover 14, trays 16 and 17, and reagent containers 12 and 13 are so configured and dimensioned that they are adapted for forming a self-supporting assembly when they are put together. In one embodiment at least one outer surface of this self-supporting assembly is suitable for fixing on it a label 28 such as, for example, a barcode label, which carries information on the reagents contained in reagent containers 12 and 13.

In one embodiment a machine-readable label 28 is attached to reagent kit 11. In one embodiment a portion of such a label 28 is fixed on a first surface which lies in a first plane and the remaining portion of label 28 is fixed on a second surface which lies in a second plane which is perpendicular to the first plane. In this arrangement label 28 contributes to improve the rigidity and stability of the above-described self-supporting assembly.

In one embodiment the upper part of each of reagent containers 12 and 13 snuggly fits into a cavity of kit cover 14 and the bottom part of each of reagent containers 12, 13 snuggly fits into a cavity of a corresponding tray 16, 17.

In one embodiment kit cover 14 is a snap-on assembling cover which is adapted to snap on the upper part of each of reagent containers 12 and 13. For this purpose, the inner surface of the side walls 15 of cover 14 have lugs 26 which are adapted to engage a groove 27 in the outer surface of the upper portion of reagent containers 12 and 13.

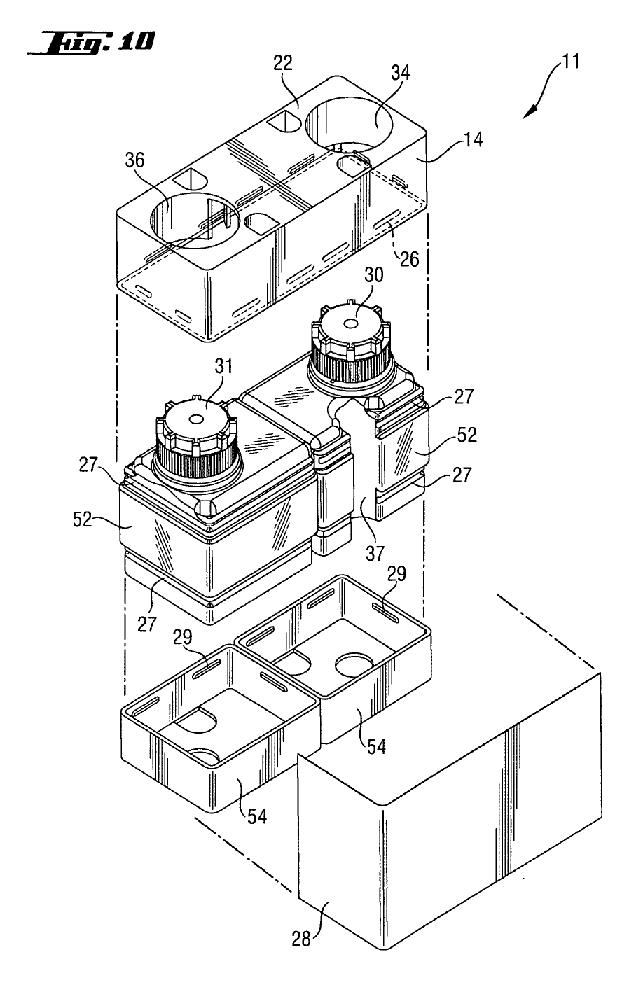

In one embodiment each of the first and second trays 16 and 17 is a snap-on tray which is adapted to snap on the bottom part of a corresponding one of reagent containers 12 respectively 13 when the latter are assembled together. For this purpose, the inner surface of the side walls 18, 19 of trays 16 respectively 17 have lugs 29 which are adapted to engage a groove 27 in the outer surface of the lower portion of reagent containers 12 and 13. Lugs 26 and 29, as well as grooves 27 are shown by FIGS. 3 to 7 and by FIG. 9.

In one embodiment kit cover 14 and trays 16, 17 are made of a first plastic material and reagent containers 12 and 13 are made of a second plastic material, and the first plastic material is more rigid than the second plastic material.

In one embodiment kit cover 14, reagent containers 12 and 13, and trays 16 and 17 are made of an opaque material. This protects the reagents from environmental light and increases the time period over which the reagent kits can be stored before they are used.

In one embodiment, reagent containers 12, 13 are made of a suitable plastic material, and in other embodiments are made of a high density polyethylene (HDPE), and in still other embodiments are made of Purell PE GF 4750 of Basell (manufacturer) containing a 2% black color batch, e.g. No. Cogranu UN 040.32 of Polyplast (manufacturer).

In one embodiment cover 14 and trays 16, 17 are made of a suitable plastic material, and in other embodiments are made of an impact resistant polystyrol, and in still other embodiments are made of a thermoplastic styrene-butadiene copolymer, and in yet other embodiments are made of SB-Empera 514 of BP (manufacturer) containing a 2% black color batch, e.g. HS7037 of Schulmann (manufacturer).

In one embodiment kit cover 14 has webs 22, 23, 24, 25 adapted for being gripped by a gripper which is carried by a carriage 73 of a conveyor of reagent kits shown in FIG. 12. For example, in one embodiment, the webs 22, 23, 24, 25 of kit cover 14 can be gripped through corresponding openings of kit cover 14. For this purpose portions of the gripper may be inserted through those openings.

In one embodiment and as shown by FIGS. 5 and 6, kit cover 14 has openings 34, 36 and each of trays 16 and 17 have openings 46 respectively 47, 50, 51 and all these openings are suitable for circulating air through tubular volume 21 and/or 37 within reagent kit 11.

In one embodiment each of reagent containers 12 and 13 has a substantially cuboid shape and a substantially rectangular cross-section. As shown by FIGS. 3 and 6, the bottom portion of reagent containers 12 and 13 have each a tapered cross-section that diminishes towards the bottom of the reagent container. This shape minimizes the dead volume of the reagent container, i.e. the rest volume of reagent which cannot be pipetted from the reagent container.

In one embodiment kit cover 14 and trays 16, 17 have each a cuboid shape.

In one embodiment, reagent containers 12 and 13 have each a removable screwable cap 30, 31 having a central portion which is piercable by a pipetting needle. Screwable caps 30, 31 have each the shape of a crown and are removable by means of a suitable tool and through openings 34 and 36 of kit cover 14.

As shown by FIG. 5 each of reagent containers 12, 13 has an opening 32 respectively 33 which is adapted to be closed by removable screwable cap 30 respectively 31.

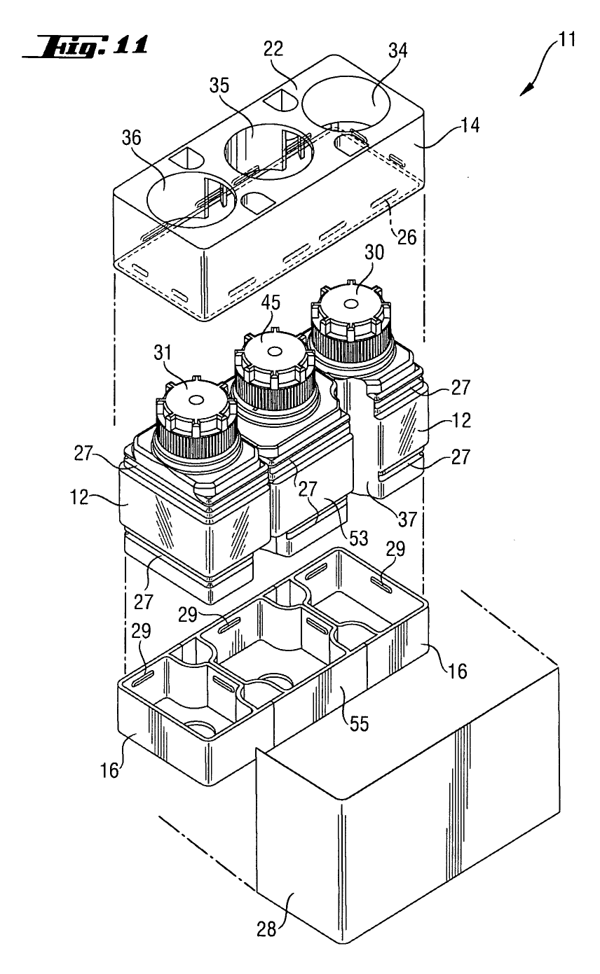

A second illustrative embodiment of a reagent kit 11 according to the present invention is described hereinafter with reference to FIG. 10.

Reagent kit 11 in FIG. 10 comprises a first reagent container 52, a second reagent container 52 and two trays 54, one for each of reagent containers 52. First reagent container 52 and second reagent container 52 have the same height and capacity. In one embodiment, reagent containers 52 have each a capacity of e.g. 40 milliliters.

The other features of this second illustrative embodiment of a reagent kit 11 are as described above with reference to FIGS. 2 to 9.

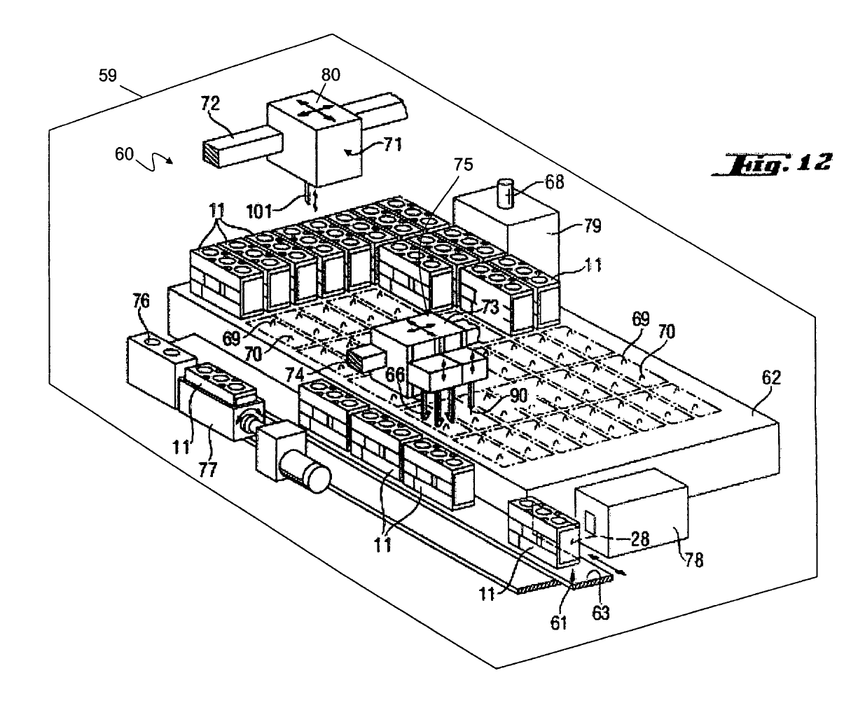

A third illustrative embodiment of a reagent kit 11 according to the present invention is described hereinafter with reference to FIG. 11.

Reagent kit 11 in FIG. 11 comprises a first reagent container 12, a second reagent container 53, and a third reagent container 12. Reagent containers 12 and 53 have the same height. In one embodiment, reagent containers 12 have each a capacity of e.g. 20 milliliters. In one embodiment, reagent container 53 has a capacity of e.g. 40 milliliters.

Reagent kit 11 in FIG. 11 further comprises a cover 14 and trays 16, 55 and 16 which correspond to reagent containers 12, 53 and 12 respectively.

In this third illustrative embodiment, cover 14 has three openings 34, 35 and 36, and reagent container 53 is closed with a removable screwable cap 45.

The other features of this third illustrative embodiment of a reagent kit 11 are as described above with reference to FIGS. 2-9.

As described hereinafter with reference to FIG. 12, an automatic analytical apparatus 60 according to the present invention is adapted to hold a plurality of reagent kits 11 of the above-described type. In one embodiment, the analytical apparatus 60 is part of an automatic clinical chemistry analyzer, indicated generally by reference symbol 59. As shown in FIG. 12, the analytical apparatus 60 contains an input/output station 61 for inserting new reagent kits 11 into the apparatus, and for discharging used reagent kits 11 from the apparatus.

The analytical apparatus 60 shown in FIG. 12 also has a carrier plate 62 on which reagent kits 11 received in the analytical apparatus are disposed and arranged in a predetermined matrix, projections 69, 70 being provided for exact positioning of the reagent kits 11 onto carrier plate 62. There also is a conveyor (see e.g., 63, 73 and 66) for conveying reagent kits 11 from input/output station 61 to carrier plate 62, or from this carrier plate 62 to input/output station 61, and optionally to other positions inside the analytical apparatus 60, and an automatic pipetting device 71 for carrying out pipetting operations as required in the analytical apparatus 60. These pipetting operations include removal of given volumes of reagent from reagent containers within reagent kits 11 and transfer of those volumes to reaction vessels (e.g. reaction vessel 68), each of which contains a specimen for examination. Each reagent container is closed by a closure which can be perforated by a pipetting needle 101 of the pipetting device 71.

A central control device (not shown in FIG. 12) controls all the operations in the analytical apparatus 60.

Carrier plate 62 can be cooled by a conventional cooling device (e.g., fan, not shown). By this means, and as a result of the aforementioned circulation of air through the reagent kits 11, the reagents contained therein are uniformly cooled.

In the illustrative embodiment shown in FIG. 12, the same location designated as symbol 61 is used as an input station and as an output or delivery station. In that case, the analytical apparatus 60 includes a display (not shown) showing the status of input/output station 61 that indicates whether station 61 is free for inserting reagent kits or whether it is occupied. Alternatively, in one embodiment, there can be separate input and output stations.

In one embodiment, up to five reagent kits 11 simultaneously can be inserted at input/output station 61. Used reagent kits 11 are automatically returned to input/output station 61, where they are discharged or removed from the apparatus 60.

As FIG. 12 shows, the analytical apparatus 60 contains a reader 78 disposed at input/output station 61 for reading machine-readable information, e.g. a bar code carried by a label 28 attached to side walls of reagent kit 11. The information on label 28 is automatically read by reader 78 when a reagent kit 11 is inserted into the input/output station 61. The information carried in machine-readable form on label 28 contains identification of a test to be performed with reagents contained in a reagent kit and parameters relating to a batch of reagents in a reagent kit.

The conveyor for conveying reagent kits 11, in one embodiment, comprises a conveyor belt 63, which transports reagent kits 11 inserted at input/output station 61 to the interior of the analytical apparatus 60 or back from there to input/output station 61, and a grippers 66 guided by a carriage 73 conveying a pipetting needle (not shown) of another automatic pipetting device 75 of the analytical apparatus 60. Grippers 66 cooperate with corresponding webs 22, 23, 24, 25 of cover 14 which can be gripped through corresponding openings of cover 14. In this way the gripper can grip reagent kit 11, e.g. from its position on carrier plate 62 or on conveyor belt 63. Carriage 73 carries the grippers 66 together with a pipetting needle (omitted for simplicity in the part of FIG. 12 which shows carriage 73), and for example, a spike 90 for penetrating and making an opening in the central part of a cap of a reagent container and thereby preparing that cap for being pierced by a pipetting needle.

Carriage 73 moves on a movable rod 74 which both belong to a conveyor of the automatic pipetting device 75 in the analytical apparatus 60. The conveyor of the automatic pipetting device 75 is used mainly for moving the pipetting needle (omitted for simplicity in FIG. 12) in three directions at right angles to one another, to a number of pipetting positions.

In the illustrated embodiment of FIG. 12, the first automatic pipetting device 71 is likewise contains a conveyor for moving a pipetting needle 101 in three directions at right angles to one another, to a number of pipetting positions. The conveyor of the first pipetting device 71 contains a carriage 80 and a movable rod 72 on which the carriage 80 moves. The carriage 80 carries pipetting needle 101.

The previously-mentioned pipetting operations are inter alia for removing given volumes of reagent from the containers contained in one of the reagent kits 11 placed on the carrier plate 62 and for transferring them to predetermined reagent vessels 68 each holding a specimen for examination. During its entire period of use in the analytical apparatus, each reagent container can be kept closed by a cap which can be perforated by pipetting needle 101 of the pipetting device 71, or can be kept open after removal of the cap of the reagent container.

As FIG. 12 shows, the analytical apparatus 60 comprises a processing station 77 in which a reagent kit disposed therein can be pivoted or rolled. If a reagent kit 11 contains a reagent container holding a reagent in freeze-dried form, the conveyor of reagent kits automatically brings such a kit to processing station 77 before the first use of the kit. At its position on the carrier plate 62, the container is filled beforehand with a suitable amount of water by pipettinG. Next, the reagent kit with the container is moved by the gripper 66, operated by the conveyor of the automatic pipetting device 75, from its position on the carrier plate 62 to the processing station 77. At station 77, the reagent kit 11 is pivoted for about 10 minutes so as to efficiently mix and completely dissolve the reagents requiring to be dissolved. All the reagents in a kit are dissolved simultaneously. After the reagents in kit 11 have been dissolved in the processing station 77, the kit is returned to its position on the carrier plate 62.

If required, reagents in certain reagent kits can periodically be re-mixed in the processing station 77 (e.g. once a day) by actuating suitable mixing means in the analytical apparatus 60.

After the freeze-dried reagents have been dissolved as described above, the reagent kit is broached as previously mentioned.

A station 76 for washing the pipetting needles (e.g. 101) is disposed alongside the processing station 77.

During operation of the analytical apparatus 60, volumes of reagent are selectively taken from a kit 11 available on the carrier plate 62 and supplied to a reaction vessel 68 in a station 79 for processing mixtures of specimen and reagent.

Although the various embodiments of the present invention have been described using specific terms, such description is for illustrative purposes only, and it is to be understood that changes and variations may be made without departing from the spirit or scope of the following claims.

What is claimed is:

1. A reagent kit adapted for being used in an automatic analytical apparatus comprising:
at least two reagent containers both having a same first height;
a kit cover configured to cover and hold upper parts of said at least two reagent containers together, said kit cover having openings which provide access to reagents contained in said at least two reagent containers, said kit cover having a side walls with a second height that is smaller than said first height of said at least two reagent containers;
a first tray configured to hold a bottom part of a first one of said at least two reagent containers; and
a second tray configured to hold a bottom part of a second one of said at least two reagent containers,
said first and second trays having each side walls with a third height that is smaller than said first height of said at least two reagent containers, and
said at least two reagent containers being so configured and dimensioned that when assembled together they fill an entire space comprised between said kit cover and said first and second trays with exception of a tubular volume which allows air circulation through said reagent kit.

2. A reagent kit according to claim 1, wherein said kit cover, said first and second trays, and said at least two reagent containers are adapted for forming a self-supporting assembly.

3. A reagent kit according to claim 2, wherein said self-supporting assembly has at least one outer surface suitable for fixing thereon a label carrying information on the reagents contained in said at least two reagent containers.

4. A reagent kit according to claim 1, further comprising a machine-readable label that is attached to said reagent kit.

5. A reagent kit according to claim 2, further comprising a label that is attached to said reagent kit, wherein said label contributes to improve rigidity of said self-supporting assembly.

6. A reagent kit according to claim 1, wherein the upper part of each of said at least two reagent containers snuggly fits into a cavity of said kit cover and the bottom part of each of said at least two reagent containers snuggly fits into a cavity of a corresponding one of said first and second traystray.

7. A reagent kit according to claim 1, wherein said kit cover is a snap-on cover which is adapted to snap on the upper part of each of said at least two reagent containers.

8. A reagent kit according to claim 1, wherein each of said first and second trays is a snap-on tray which is adapted to snap on the bottom part of a corresponding one of said at least two reagent containers when said reagent kit is assembled together.

9. A reagent kit according to claim 1, wherein said kit cover, and said first and second trays are made of a first plastic material, and said at least two reagent containers are made of a second plastic material, said first plastic material being more rigid than said second plastic material.

10. A reagent kit according to claim 1, wherein said kit cover, said at least two reagent containers, and said first and second trays are made of an opaque material.

11. A reagent kit according to claim 1, wherein said kit cover has webs adapted for being gripped by a gripper of a conveyor.

12. A reagent kit according to claim 1, wherein said kit cover has at least two first openings, and each of said first and second trays has at least one second opening, said first and second openings being suitable for circulating air through said tubular volume within said reagent kit.

13. A reagent kit according to claim 1, wherein each of said at least two reagent containers has a substantially cuboid shape and a rectangular cross-section.

14. A reagent kit according to claim 1, wherein said kit cover and said first and second trays have each a cuboid shape.

15. A reagent kit according to claim 1, wherein said at least two reagent containers have each a screwable cap having a central portion which is piercable by a pipetting needle, said screwable caps being removable through said openings of said kit cover.

16. A reagent kit according to claim 1, wherein sum of the second height and the third height is smaller than the first height.

17. An automatic analytical apparatus adapted for using a plurality of reagent kits according to claim 1, said apparatus comprising:
an input station configured to receive new reagent kits;
an output station configured to deliver used reagent kits;
a carrier plate on which said plurality of reagent kits are arranged in a matrix;
a conveyor configured to convey said plurality of reagent kits from said input station to said carrier plate, from said carrier plate to said delivery station, and optionally to other positions inside the automatic analytical apparatus,
said conveyor including a gripper configured to grip said plurality of reagent kits by gripping webs which are part of the kit cover of each of said plurality of reagent kits; and
an automatic pipetting device configured to carry out pipetting operations as required in the automatic analytical apparatus, these pipetting operations including removal of given volumes of the reagent from said at least two reagent containers of each one of said plurality of reagent kits and transfer of said volumes to at least one reaction vessel which contains a specimen for examination.

18. An automatic analytical apparatus according to claim 17 provided as part of an automatic clinical chemistry analyzer.

19. An automatic analytical apparatus according to claim 17 wherein said input and output stations are the same station.
